(19) United States
(12) Patent Application Publication
(10) Pub. No.: US 2019/0029196 A1
(43) Pub. Date: Jan. 31, 2019

(54) PORTABLE AQUAPONICS SYSTEM AND AQUAPONICS FARMING METHOD

(71) Applicant: BRIDGING INTERNATIONAL COMMUNITIES, Canton, MI (US)

(72) Inventors: Michelle Kristen LEACH, Canton, MI (US); Jacquelyn Smith Hernandez Ortiz, Suchitoto (SV)

(73) Assignee: BRIDGING INTERNATIONAL COMMUNITIES, Canton, MI (US)

(21) Appl. No.: 15/660,410

(22) Filed: Jul. 26, 2017

(51) Int. Cl. A01G 31/02; A01K 63/04; A01K 61/10; A01G 31/00; A01G 1/00

(52) U.S. Cl. CPC A01G 31/02; A01K 63/047; A01G 1/001; A01G 31/001; A01K 61/10

(57) ABSTRACT

This invention provides, among other things, an aquaponics system which comprises two tanks made of a lightweight, collapsible material. The first tank is configured to hold a volume of water sufficient to raise aquatic animals. The second tank is configured to hold a volume of planting medium that is suitable for growing crops. The aquaponics system of the invention is more easily assembled, disassembled, and transported compared to other aquaponics systems.

### FIELD OF THE INVENTION

The present invention pertains to aquaponics systems and methods, and more particularly to aquaponics systems and methods using collapsible materials.

### BACKGROUND OF THE INVENTION

Aquaponics involves combining aquaculture, the raising of aquatic animals, and hydroponics, the cultivation of plants in water, in a combined symbiotic system. In such systems, waste products from aquatic animals in the aquaponic system are used as nutrients for the plants in the aquaponic system. In turn, the plants purify the water for the aquatic animals. This is accomplished by bacteria converting ammonia in the water to nitrites and then to nitrates. These nitrates are absorbed by the plants as nutrients, leading to simultaneously fertilizing the plants while purifying the water for the aquatic animals. In this way, aquatic animals and crops can be grown more efficiently than they could be separately, helping to create a stable, diverse, and sustainable food source.

These types of systems are especially helpful in the developing world. In many developing nations, space for agriculture can be highly limited due to unfavorable soil conditions and overcrowding. Food diversity is also often a problem, with many regions relying on a few staple crops as the primary food source, which can lead to deficiencies in essential nutrients. In addition, in low income areas the ability to grow additional food means that sale of the surplus can help supplement individual income.

However, there are numerous drawbacks to existing aquaponics systems that especially cause problems in the developing world. The tanks used in these systems are normally made from whatever materials are available in the area, such as tanks constructed from cement, wood, fiberglass or metal. Existing designs also require the tanks to be stacked vertically, meaning that large, heavy, and expensive structures of wood, stone, or concrete are needed to be used in the frame of the system. This has made mass production of such systems very costly, as the materials are expensive, and due to their bulk and weight complete systems are prohibitively expensive to ship. Since most in developing nations have low incomes and cannot afford an expensive system, there is a need for an aquaponics system that can be mass produced and shipped easily in order to lower the costs as much as possible.

### SUMMARY OF THE INVENTION

In one embodiment there is provided an aquaponics system. The system of this embodiment includes a first tank comprising a first collapsible material, wherein the first tank is configured to hold a volume of water sufficient to raise aquatic animals, and a second tank comprising a second collapsible material, wherein the second tank is configured to hold a planting medium. A first tube is fluidly connected to the first tank and the second tank to allow the flow of water therebetween. A pump is fluidly connected to the second tank, and the pump is activated when a water level condition is met. A second tube is fluidly connected to the first tank and the pump to allow the flow of water therebetween.

In another embodiment, there is provided a method of manufacturing a collapsible vessel to be used in an aquaponics system. This method includes forming a base shape from a collapsible material, wherein the perimeter of the base shape comprises a base attachment edge. A plurality of wall panels is formed from the collapsible material. Each wall panel is shaped that it can be affixed to the base attachment edge of the base shape via a bottom attachment edge and affixed to an adjacent wall panel via a side attachment edge. The base attachment edge of the base shape is affixed to the bottom attachment edge of the wall panel such that a water-tight seam is formed. Side attachment edges of each wall panel are affixed to the side attachment edges of each adjacent wall panel such that a water-tight seam is formed. The resulting collapsible vessel has a mouth with an opening that is smaller than the base.

In another embodiment, there is provided an aquaponics farming method. This farming method comprises setting up an aquaponics system as previously described. The first tank of the aquaponics system is filled with water. The second tank of the aquaponics system is filled with the planting medium. The plurality of aquatic animals is added to the first tank. A plurality of plants is planted in the second tank. Water is drained from the first tank to the second tank via the first line of tubing. Water is pumped from the second tank to the first tank via the pump when the water level condition is met.

### BRIEF DESCRIPTION OF THE DRAWINGS

FIG. 1 illustrates an aquaponics system in accordance with a preferred embodiment of the present invention.

FIG. 2 illustrates an aquaponics system in accordance with another embodiment of the present invention, in which the pump is not disposed within the second tank.

FIG. 3 illustrates an aquaponics system in accordance with another embodiment of the present invention, in which the pump is powered via a solar generator and battery.

FIG. 4 illustrates a design of the second tank involving a support structure in accordance with another embodiment of the present invention.

FIG. 5 illustrates a design of the frame connectors used to support the second tank in accordance with one embodiment of the present invention.

FIG. 6 illustrates a base shape and side wall panels of an unassembled collapsible vessel to be used in an aquaponics system, in accordance with one embodiment of the present invention.

### DETAILED DESCRIPTION OF THE INVENTION

An aquaponics system is provided herewith that improves on previous aquaponics designs. This may be accomplished by having two tanks formed of collapsible materials, preferably in a configuration in which the tanks are arranged in the same horizontal plane as each other. The first tank is configured to hold a volume of water such that aquatic animals can be raised therein. The second tank is configured to hold a planting medium such that plants may be grown therein. The tanks are fluidly connected via a first tube, which allows the draining of water from the first tank to the second tank. A pump is fluidly connected to the second tank that activates when a water level condition is met, with a second tube that fluidly connects the pump to the first tank. In one embodiment, the pump is disposed in the second tank. In another embodiment, there is a third tube which fluidly connects the second tank to the pump. Preferably, the pump is activated by one or more float switches to detect when the water condition is met. For example, the one or more float switches may be configured such that the pump is activated whenever the water level in the second tank rises up to a predetermined level. When a tube of constant diameter is used to connect the first tank to the second tank, the period of time needed for the water from the first tank to fill the second tank up to the predetermined level is essentially constant. In this way, by using one or more float switches that are activated when the water in the second tank reaches the predetermined level, the growing bed of the second tank is periodically flooded and drained. This is advantageous because it causes oxygen to be drawn down to the bacteria living in the gravel of the growing bed, thereby facilitating the conversion of toxic nitrites to nitrates. Of course, the invention is not limited to the use of float switches, and the invention expressly contemplates other mechanisms that can cause periodic flooding and draining of the growing bed of the second tank. For example, in certain embodiments, the pump is activated by a timer and preferably one that cycles the pump based on the filling rate of the second tank by the tube connected to the first tank.

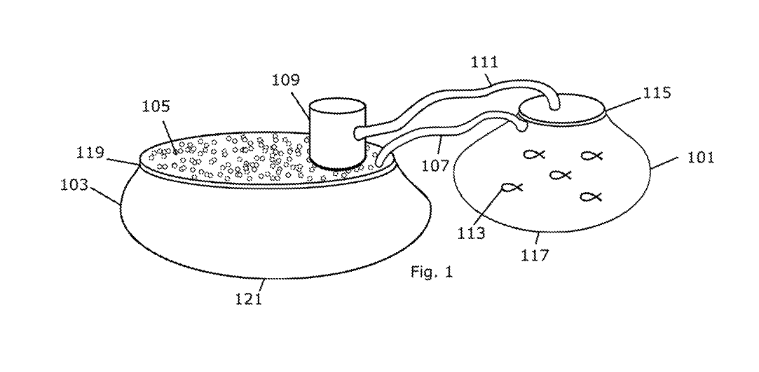

Referring to FIG. 1, an aquaponics system according to one embodiment of the aquaponics system disclosed herein is shown. This system includes a first tank 101 made of a collapsible material, which is configured to hold a volume of water such that aquatic animals 113 can be raised therein. This system also includes a second tank 103, made of a collapsible material, which is configured to hold a planting medium 105 such that plants may be grown therein.

The first tank 101 is fluidly connected to the second tank 103 via a first tube 107, which allows the flow of water therebetween. This can be arranged such that water from the first tank 101 can drain through the first tube 107 into the second tank 103. This allows the water of the first tank 101, which is rich in nutrients due to the metabolic processes of the aquatic animals 113, to be used to water the plants growing in the planting medium 105 of the second tank 103.

The second tank 103 is fluidly connected to a pump 109. The pump 109 is also fluidly connected to the first tank 101 via a second tube 111. The pump 109 is activated when a water level condition is met, causing water to be pumped from the second tank 103 to the first tank 101. This allows water that has been filtered by the plants and the planting medium 105 in the second tank 103 to refill the first tank 101. In the preferred embodiment, the pump 109 is disposed within the second tank 103.

The materials used for the tubes 107 and 111 are not particularly limited and may be any lightweight material that is biocompatible with the aquaponic system. In preferred embodiments, the tubes 107 and 111 are constructed of a polymeric material, such as rigid polyvinyl chloride (PVC), flexible PVC, polyethylene, polypropylene, and the like. The diameter of tube chosen for a particular aquaponic system will depend on the size of the first tank, the size of the second tank, and the desired rate of drainage from the first tank to the second tank. In general, useful tube diameters are in the range of about 1 to about 4 inches, preferably about 2 to about 3 inches in diameter. The tubes 107 and 111 may be secured to the first tank and second tank using standard fittings as is known in the art.

The pump 109 may be connected to the local electrical grid to supply power. However, not all areas of the world have ready or reliable access to electricity. Accordingly, this invention contemplates the use of alternative energy sources to power pump 109, non-limiting examples of which include solar power, wind power, geothermal power, hydroelectric power, and even manual power. For example, one embodiment of the invention includes a solar generator and a battery, where the solar generator is electrically connected to the battery such that the solar generator charges the battery when exposed to sunlight. The battery is electrically connected to the pump 109 such that the battery provides electrical power to the pump 109 when it is activated. This removes reliance on a local electrical grid while still allowing the pump 109 to function when the sun has set or is blocked by cloud cover.

The first tank 101 and second tank 103 each comprise a material that is sufficiently flexible that it is collapsible, although they need not each be made of the same collapsible material. In a preferred embodiment of the invention, the collapsible material of the first tank 101 and the collapsible material of the second tank 103 each comprises a polymer. The selection of suitable polymers is not particularly limited and can be any polymer that has the requisite strength (even at the thicknesses described herein), weather durability, and low toxicity. In certain embodiments, the polymer is a polyolefin, non-limiting examples of which include polyethylene, polypropylene, polybutylene, polystyrene, vinyl polymers, and combinations thereof. Suitable thicknesses of the polymeric material that is used to fabricate the tanks according to the invention are in the range of 10 to 100 mil, 12 to 50 mil, or 14 to 24 mil. In general, while the polymeric materials used to fabricate the aquaponic system of the invention are sufficiently flexible to be collapsible for convenient transport and/or storage, they are capable of maintaining sufficient strength to be used in the aquaponics system provided. By being collapsible, the first tank 101 and second tank 103 are lighter in weight and can be stored in smaller packaging than traditional rigid designs such as barrels, which makes each aquaponics system less expensive and easier to ship, move, and store.

One aspect of the invention is the recognition that it is advantageous for the volume of the first tank 101 for the aquatic animals 113 to be greater than the volume of the second tank 103 for the hydroponic cultivation of plant crops contemplated by the invention. In other words, in certain preferred embodiments, the volume of the first tank 101 is greater than or equal to the volume of the second tank 103. It should be noted that, in most embodiments, the volume of the second tank 103 used for hydroponic cultivation of plant crops is completely filled with the hydroponic planting medium 105, such that the volume of the second tank 103 is the essentially the same as the volume of the planting medium 105 that is used. With this understanding, it should be noted that in certain preferred embodiments, the ratio of the volume of water in the first tank 101 (expressed in gallons) to the volume of the planting medium 105 (expressed in cubic feet) is 500:10, 500:20, 500:30, 500:40, 400:10, 400:20, 400:25, 400:30, or 400:40. In one particular preferred embodiment, the first tank 101 for raising the aquatic animals is configured to contain 400 gallons of water, while the hydroponic portion of the system contains 24 cubic feet of planting medium 105.

In general, the planting medium 105 that may be used with the aquaponic systems of the invention are not particularly limited and may be any planting medium 105 that is non-toxic, permits root growth, and does not adversely affect that quality of the water in the aquaponic system. There are many different types of planting medium 105 that plants can grow in in such an aquaponics system. In the preferred embodiment of the invention, the planting medium 105 is comprised of gravel. Gravel is well suited to filtering the nutrient rich water of the system, collects nutrients for the plants, does not inhibit root growth, and easily drains when the pump 109 is activated. Preferably, this gravel does not comprise limestone, as limestone gravel tends to raise the pH of the system which is detrimental to aquatic animal 113 and plant growth. Other planting media contemplated by the invention include, without limitation, pumice, sand, wood fibers, brick shards, vermiculite, plant husks (e.g., coco peat), clay pellets, plastic media (e.g., “Sure to Grow™”, polystyrene packing peanuts), and perlite. The invention also contemplates the use of mixtures of such media.

In the preferred embodiment of the invention, the first tank 101 and the second tank 103 are arranged in the same horizontal plane. For example, first tank 101 and second tank 103 may be arranged such that they are adjacent to each other and are both resting on the ground. By configuring the first tube 107 to allow water to drain from the first tank 101 to the second tank 103 horizontally, the need for a large rigid structure to hold one tank vertically above the other is removed. Without the need for these traditional structures, which were often made of large and heavy materials such as wood or stone, the system is cheaper to set up, is easier to ship, and is able to be used in more environments. Of course, the invention also contemplates configurations where one of the tanks is held above the other. For example, in certain embodiments, the aquaponic system of the invention may be arranged on terraced land, such that one of the tanks of the system is above the other. Such a configuration does not depart from the spirit and scope of the invention.

In the preferred embodiment of the invention, the first tank 101 comprises a top opening 115 and a base 117, wherein the perimeter of the top opening 115 is smaller than the perimeter of the base 117. Similarly, the second tank 103 comprises a top opening 119 and a base 121, wherein the perimeter of the top opening 119 is smaller than the perimeter of the base 121. In certain preferred embodiments, the walls of the first tank 101 and second tank 103 bulge outwards, as shown in FIG. 1. By forming the first tank 101 and second tank 103 in this way, a larger volume of water can be stored in the first tank 101 and a larger volume of planting medium 105 can be stored in the second tank 103 for a given footprint size of the first tank 101 and second tank 103. The first tank's 101 narrower top opening 115 also helps the first tank 101 stand upright and prevent water from spilling out. Similarly, the second tank's 103 narrower top opening 119 also helps the second tank 103 stand upright and prevents water and planting medium 105 from spilling out.

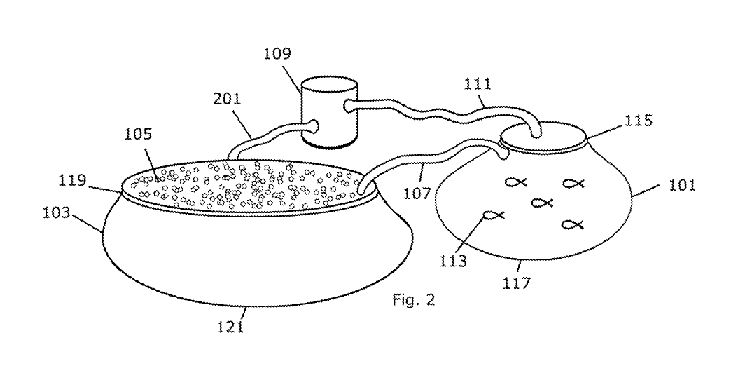

Referring to FIG. 2, an aquaponics system according to another embodiment of the aquaponics system disclosed herein is shown. This system is similar in structure and function to the earlier embodiment disclosed in FIG. 1, with the addition of a third tube 201 fluidly connecting the second tank 103 to the pump 109. This pump 109 is still arranged such that water is pumped from the second tank 103 to the first tank 101 through the second tube 111, but now uses the third tube 201 to fluidly connect the input of the pump 109 to the second tank 103. This allows different models of pump 109 to be used as well as different layouts of the system that may be preferable in certain environments, such as allowing the pump 109 to be moved out of the elements to improve its longevity in certain climates.

In another embodiment of this invention, one or more float switches are used, which activates the pump when a certain water level condition is met. For example, the one or more float switches may be disposed within the second tank 103 to detect when the water level is too high to activate the pump 109. Multiple float switches can be configured such that the pump 109 activates when the water level reaches a certain maximum in the second tank 103 and deactivates when a lower water minimum is met. A float switch can also be disposed in the first tank 101, to activate the pump 109 if the water level falls below some minimum level. A second float switch may be used in the first tank 101 to deactivate the pump 109 when a certain water maximum is met.

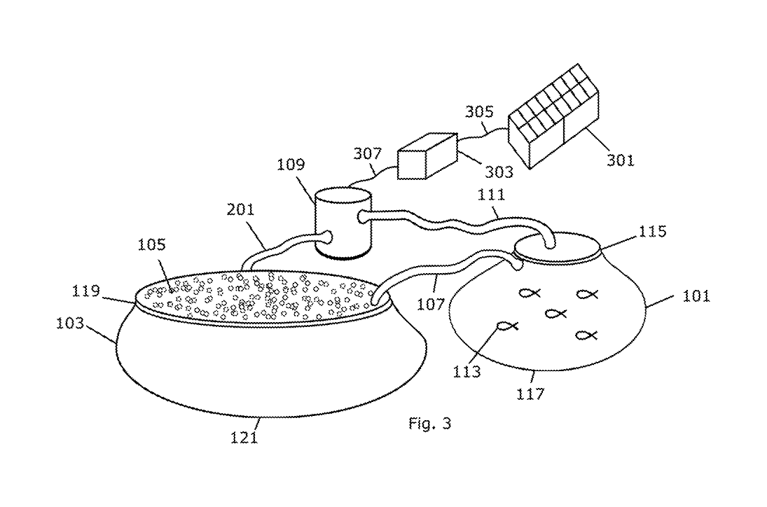

Referring to FIG. 3, an aquaponics system according to another embodiment of the aquaponics system disclosed herein is shown. This embodiment is similar to those previously discussed, but includes the ability to be solar powered rather than relying on an established power grid. This system includes a solar generator 301 and battery 303, with the solar generator 301 electrically connected to the battery 303, and the battery 303 electrically connected to the pump 109. During periods of sunlight, the solar generator 301 generates electricity to charge the battery 303, which discharges when the pump 109 is active. A charge controller manages the electrical connection between the solar generator 301 and the battery 303, which ensures the battery 303 is not overcharged and the solar generator 301 does not drain the battery 303 during periods without sunlight. The charge controller may be a part of the solar generator 301, the battery 303, or a standalone device electrically connected between the solar generator 301 and the battery 303. The solar generator 301 and battery 303 may be a single combined device, or may be two separate devices that are electrically connected via a first wire 305. Similarly, the battery 303 and pump 109 may be a single combined device, or may be two separate devices that are electrically connected via a second wire 307. The battery 303 enables the pump 109 to continue to function when power is not being provided by the solar generator 301, such as at night and during periods without direct sunlight. The use of a solar power enables the aquaponics system to function without an established electrical grid or where there is unreliable electrical service.

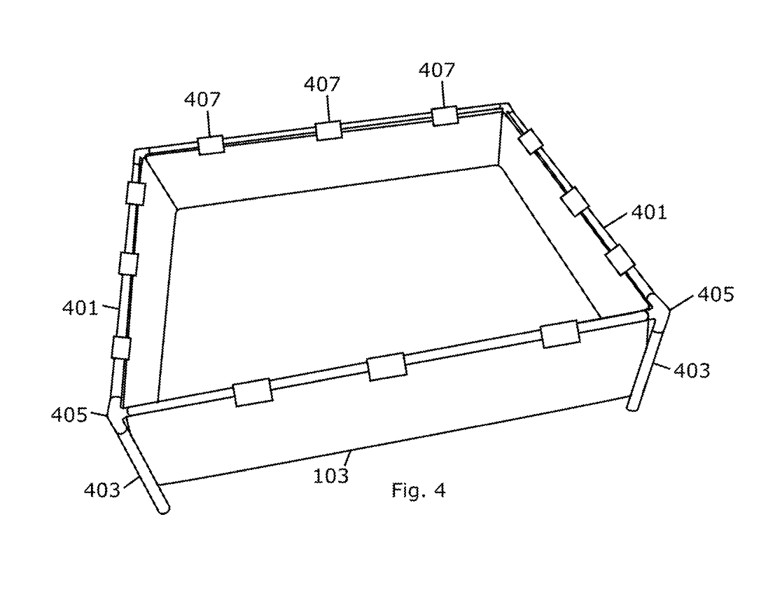

Referring to FIG. 4, an alternate design of the second tank 103 according to another embodiment of the aquaponics system disclosed herein is shown. In this embodiment, a plurality of support members 401 are provided, which are affixed to each other at their ends. Two support members 401 can either be affixed directly to each other or indirectly affixed via a joint 405. The connection of support members 401 with or without joints 405 form a frame. A plurality of ground supports 403 have one end affixed to the frame, with the other end contacting the ground. Each ground support 403 can either be affixed to a joint 405 or directly to a support member 401.

The support members 401 of the frame are connected to the second tank 103 via a plurality of frame connectors 407. Connecting the second tank 103 to the support members 401 of the frame in this way provides support from above to the second tank 103. This support allows the second tank 103 to better hold its shape and makes it less prone to breakage due to being supported from above by the frame. This is particularly advantageous in applications where the second tank 103 has a greater volume or is fabricated using thinner polymeric materials.

The selection of suitable materials for the support members 401, ground supports 403, and joints 405 is not particularly limited and can be any material that has the requisite strength to support the second tank 103. Preferably, the material used is lightweight, inexpensive, and easy to disassemble and store. In the preferred embodiment, PVC pipe and connectors is used. However, other materials are contemplated, non-limiting examples of which include other plastics, metal, wood, rope, chain, and bamboo, among others.

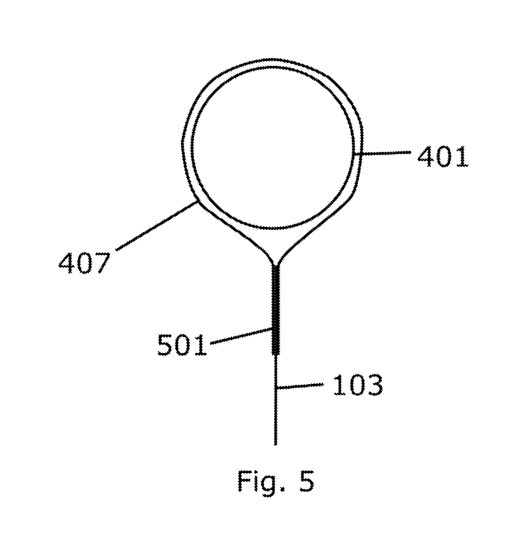

Referring to FIG. 5, one embodiment of frame connector 407 in accordance with the present invention is provided. In this embodiment, the frame connector 407 comprises a section of the same collapsible material as the second tank 103. One end of the collapsible material is affixed to the inner wall of the second tank 103, and the other end is affixed to the outer wall of the second tank 103, together forming a seam 501. The shape of the collapsible material in the frame connector 407 forms a loop, which allows a support member 401 to be placed through it. This loop allows the frame connector 407 to be supported by the support member 401, while the seam 501 allows the frame connector to support the second tank 103. Other methods of forming a frame connector 407 that enables the support member 401 to support the second tank 103 are contemplated. In one embodiment, the collapsible material of the second tank 103 is looped around the support member 401 and affixed to the other side of the second tank 103 to form a frame connector. In another embodiment, hooks are affixed to the support member 401 to form a frame connector 407, connecting the support member 401 to grommets installed into the second tank 103. Other forms of frame connector 407 are contemplated, preferably ones which enable easy separation of the support member 401 from the second tank 103 for ease of disassembly and storage.

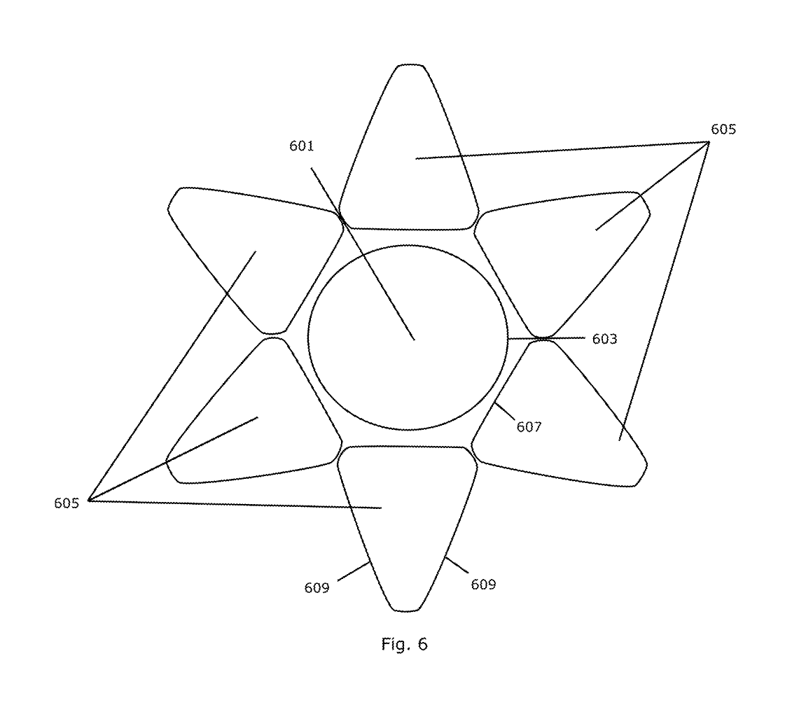

Referring to FIG. 6, a method of manufacturing a collapsible vessel to be used in the aquaponics system as previously described is also disclosed. This method includes forming a base shape 601 from a collapsible material and forming a plurality of wall panels 605 from the collapsible material. The base shape 601 is preferably rounded, with the perimeter forming a base attachment edge 603. A plurality of wall panels 605 is also formed using the collapsible material, with each wall panel 605 comprising a bottom attachment edge 607 and two side attachment edges 609. The wall panels 605 are made such that the bottom attachment edge 607 is wider than the opposite edge, such that the side attachment edges 609 taper closer together. The bottom attachment edge 607 of each wall panel 605 is then affixed to the base shape 601 along the base attachment edge 603. Finally, the side attachment edges 609 of each wall panel 605 are then affixed to the side attachment edge 609 of each adjacent wall panel 605. The resulting collapsible vessel should have a mouth with an opening that is smaller than the base, due to the tapered wall panels 605. The act of affixing two edges forms a water-tight seam between the base shape 601 and the wall panel 605 or between the two wall panels 605. In the preferred embodiment, the method of affixing the edges of the collapsible material is heat welding, which is fast, efficient, and results in a water-tight seam.

In the preferred embodiment of the method, the material used to form the base shape 601 and wall panels 605 comprises a polyolefin, such as polyethylene, polypropylene, polybutylene, polystyrene, vinyl polymers, and combinations thereof. Using such materials as described herein, one can create aquaponic tanks that are sufficiently flexible to be collapsible for convenient transport and storage, while still maintaining sufficient strength to be used in the aquaponics system provided. They can also be heat welded to join the edges and form a water-tight seam.

An aquaponics farming method is also disclosed using the aquaponics system previously described. The first tank 101 of the aquaponics system is filled with a volume of water, while the second tank 103 is filled with the planting medium 105. The plurality of aquatic animals 113 are added to the first tank. A plurality of plants is planted in the second tank. The metabolic processes of the aquatic animals 113 results in the water contained in the first tank 101 to become rich with nutrients for the plants in the second tank. This nutrient-rich water flows from the first tank 101 to the second tank 103 via the first tube 107. The planting medium 105 and plants in the second tank 103 clean the water, filtering out those nutrients and using them to fertilize the plants. When the water level condition is met, water is pumped by the pump 109 from the second tank 103 to the first tank 101 via the second tube 111, refilling the first tank 101 with clean water to repeat the process.

In certain embodiments, the aquatic animals 113 are freshwater aquatic animals that are suitable for use as human food. For example, in a preferred embodiment, the aquatic animals 113 are bony fish, non-limiting examples of which include tilapia, trout, carp, catfish, largemouth bass, smallmouth bass, perch, pacu, sunfish, whitefish, walleye, bluegill, freshwater eels, giant gouramis, and the like. Tilapia is particularly preferred due to its hardy nature. The invention also contemplates the use of freshwater shellfish, including mussels, clams, shrimp, snails, and crayfish. In other embodiments, the freshwater aquatic animals used in the aquaponics system of the invention are not intended for use as human food, but have some other economic value. For example, the freshwater aquatic animals may be ornamental fish that are typically sold for aquariums, such as neons, guppies, tetras, swordfish, and mollies.

Many different types of plant crops may be cultivated using the aquaponic systems of the invention, non-limiting examples of which include tomatoes, green peppers, eggplants, cucumbers, green beans, squash, broccoli and cauliflower, cabbage, bok choy, lettuces, spinach, Swiss chard, watercress, peas (snow peas and sugar snaps), and green onions. Fruit, including grapes, strawberries, raspberries, blackberries, blueberries, and even melons (e.g. watermelon or cantaloupe) may be cultivated using the aquaponic systems of the invention.

While the above described embodiments of the invention are described in terms of preferred ranges, preferred materials, and preferred shapes of the tanks used in connection with the aquaponic systems of the invention, these preferences are by no means meant to limit the invention. From the foregoing description, one of ordinary skill in the art can easily ascertain the essential characteristics of the instant invention, and without departing from the spirit and scope thereof, can make various changes and/or modifications of the invention to adapt it to various usages and conditions. As such, these changes and/or modifications are properly, equitably and intended to be, within the full range of equivalence of the following claims.

What is claimed is:

1. An aquaponics system comprising:
a first tank comprising a first collapsible material, wherein the first tank is configured to hold a volume of water sufficient to raise aquatic animals;
a second tank comprising a second collapsible material, wherein the second tank is configured to hold a volume of planting medium;
a first tube that is fluidly connected to the first tank and the second tank to allow the flow of water therebetween;
a pump that is fluidly connected to the second tank, wherein the pump is activated when a water level condition is met; and
a second tube that is fluidly connected to the first tank and the pump to allow the flow of water therebetween.

2. The aquaponics system of claim 1, wherein the first tank and the second tank are arranged in the same horizontal plane.

3. The aquaponics system of claim 1, wherein the pump is disposed in the second tank.

4. The aquaponics system of claim 1, wherein the pump is activated by one or more float switches that detect when the water level condition is met.

5. The aquaponics system of claim 4 further comprising a third tube that fluidly connects the second tank to the pump.

6. The aquaponics system of claim 1, wherein the planting medium comprises gravel not made from limestone.

7. The aquaponics system of claim 1, wherein the first collapsible material and the second collapsible material comprises a polyolefin.

8. The aquaponics system of claim 8, wherein the polyolefin of the first collapsible material and polyolefin of the second collapsible material are independently selected from the group consisting of polyethylene, polypropylene, polybutylene, polystyrene, vinyl polymers, and combinations thereof.

9. The aquaponics system of claim 1, wherein the first tank comprises a top opening and a base, wherein the perimeter of the top opening is smaller than the perimeter of the base, and the second tank comprises a top opening and a base, wherein the perimeter of the top opening is smaller than the perimeter of the base.

10. The aquaponics system of claim 1, wherein the aquaponics system further comprises the ratio of the volume of the aquatic animal vessel and the volume of the planting vessel is approximately between 1:1 and 5:1.

11. The aquaponics system of claim 1 further comprising a solar generator and a battery, wherein the solar generator is electrically connected to the battery and the battery is electrically connected to the pump.

12. The aquaponics system of claim 1 further comprising:
a plurality of support members each comprising two ends, wherein each end of each support member is affixed to an end of another support member to form a frame;
a plurality of ground supports each comprising two ends, wherein one end is affixed to the frame and the other end contacts the ground; and
a plurality of frame connectors, wherein each frame connector connects one of the support members of the frame to the second collapsible material of the second tank.

13. A method of manufacturing a collapsible vessel to be used in an aquaponics system, comprising:
forming a base shape from a collapsible material, wherein the perimeter of the base shape comprises a base attachment edge;
forming a plurality of wall panels from the collapsible material, such that each wall panel is shaped that it can be affixed to the base attachment edge of the base shape via a bottom attachment edge and affixed to an adjacent wall panel via a side attachment edge;
affixing the base attachment edge of the base shape to the bottom attachment edge of the wall panel such that a water-tight seam is formed; and
affixing the side attachment edges of each wall panel to the side attachment edges of each adjacent wall panel such that a water-tight seam is formed;
wherein the collapsible vessel has a mouth with an opening that is smaller than the base.

14. The method of claim 14, wherein the method of affixing the edges of the collapsible material is heat welding.

15. The method of claim 15, wherein the collapsible material comprises a polyolefin.

16. The method of claim 16, wherein the polyolefin of the collapsible material are selected from the group consisting of polyethylene, polypropylene, polybutylene, polystyrene, vinyl polymers, and combinations thereof.

17. An aquaponics farming method, comprising:
setting up an aquaponics system as described in claim 1;
filling the first tank of the aquaponics system with water;
filling the second tank of the aquaponics system with the planting medium;
adding a plurality of aquatic animals to the first tank;
planting a plurality plants in the second tank;
draining water from the first tank to the second tank via the first tube; and
pumping the water from the second tank to the first tank via the pump when the water level condition is met.

18. The aquaponics farming method of claim 18, wherein the plurality of aquatic animals comprise fish.

19. The aquaponics farming method of claim 19, wherein the fish are selected from the group consisting of tilapia, trout, carp, catfish, largemouth bass, koi, goldfish, and combinations thereof.
